(19) United States
(12) Patent Application Publication
(10) Pub. No.: US 2013/0013912 A1
(43) Pub. Date: Jan. 10, 2013

(54) Systems and Methods for Securing Media and Mobile Media Communications with Private Key Encryption and Multi-Factor Authentication

(76) Inventors: Peter W. Rung, (US); Mary Claire Ryan, (US); David S. Boubion, (US)

(21) Appl. No.: 13/543,535

(22) Filed: Jul. 6, 2012

Related U.S. Application Data
(60) Provisional application No. 61/504,773, filed on Jul. 6, 2011.

(51) Int. Cl. H04L 9/28

(52) U.S. Cl. 713/150

(57) ABSTRACT

Systems and methods protect and secure one-path and/or multi-path data, media, multi-media, simulations, gaming, television and mobile media communications and their fixed or mobile devices over diverse networks with symmetric key rotation, various forms of encryption, and multiple factors of authentication to provide optimal security for the integrity of any media asset. The distribution of said media asset is driven through virtual servers with effective stealth or cloaked processes, rendering them invisible to outside attacks, and securing any media from internal theft during the distribution process. The systems and methods curtail the ability to copy and/or revise the protected media and are instrumental in preventing piracy of media assets over the Internet, intranets, or private networks.

The present invention claims priority to U.S. Provisional Patent Application No. 61/504,773, entitled, “Systems and Methods for Securing Media and Mobile Media Communications with Private Key Encryption and Multi-factor Authentication,” filed Jun. 6, 2011, which is incorporated herein by reference in its entirety.

### TECHNICAL FIELD

The present invention relates to systems and methods for protecting and securing one-path and/or multi-path data, media, multi-media, simulations, gaming, television, audio and mobile media communications and their fixed and/or mobile devices over diverse networks with symmetrical key rotation, various forms of encryption, and multiple factors of authentication to provide optimal security for the integrity of any media asset. The distribution of said media asset is driven through one or more virtual servers with effective stealth or cloaked process, rendering them invisible to outside attacks, and securing any media from internal theft during the distribution process. The present invention curtails the ability to copy and/or revise the protected media and is instrumental in preventing piracy of media assets.

### BACKGROUND

It is, of course, known to send information through conventional telephony and/or through the Internet, security of the information has traditionally been difficult. Heretofore known systems and methods may allow the recipient the ability to utilize the information, but it has been difficult to both prevent the information from falling into the wrong hands and, if received by an unauthorized third party, preventing the unauthorized third party from utilizing the information.

Information delivery is traditionally handled using communication protocols over the Internet. These communication protocols include applications that may aid in securing the transfer of information, such as, but not limited to, encryption ciphers, passwords, tokens, biometrics, and secured card/chip technology.

However, typical and conventional communication protocols lack efficient security and cryptographic encryption for secure communication. For example, typical and conventional communication protocols do not provide adequate encryption of data, such as encryption of voice, data, text, media and the like.

Moreover, typical and conventional communication protocols lack proper cloaking technology for cloaking the presence of vital data and applications at the device or server levels. Security for the transmission of data via the Internet currently exists, but is typically applied network-wide, and is typically not specifically related to the data being transmitted.

A need exists for systems and methods for securing all forms of media, including but not limited to, mobile media, mobile media player applications, video, video streaming, audio, audio streaming, and video games, movies and television to integrate or concatenate information communications over multiple and diverse networks and systems simultaneously.

Moreover, a need exists for systems and methods for providing enhancements to the concatenated communication stream with multi-factor authentication, multiple encryption algorithms, and multiple rotating keys for the encryption algorithms. Currently the media, multimedia distribution, gaming and other industries do not have methodologies that secure multimedia assets, including at the distribution point of said multimedia assets. As a consequence, billions of dollars of revenue has been lost within the entertainment industry as a result of pernicious piracy.

### SUMMARY OF THE INVENTION

The present invention pertains to a securitized system for the storage, purchase, distribution, and overall integrity of multimedia assets whereby said architecture enables a more cost efficient and robust methodology for the commercial application and sale of multimedia assets via the Internet utilizing one or many virtual public or private cloud based servers leveraging existing multimedia assets at its source.

The present invention embodies an architecture that delivers secured multimedia content that will run on one or more commercial endpoint devices with a secure mobile media application player through a dedicated set of secure servers, virtual or physical. This secure mobile media application player may be in the form of a stand-alone application, or it may be in the form of a plug-in of an existing player. Streaming media is uniquely encrypted on a per user device basis, with up to ‘X’ devices supported per user, where ‘X’ is one or more. Once installed, the secure mobile media application player can generally only run on the one or more devices it was installed on.

In an embodiment, a method of delivering secure multimedia content is provided. The method comprises the steps of providing an endpoint device; providing a mobile media application player on the endpoint device; and delivering secured multimedia content to the endpoint multimedia device via one or more dedicated physical or virtual servers, including cloud computing infrastructures to play on the mobile or fixed media application player, wherein the secured multimedia content is uniquely encrypted to play only on the mobile media application player on the endpoint device.

In an embodiment, a security application incorporating but not limited to AES 256 bit encryption can integrate or concatenate information communications and/or multi-media assets, including but not limited to voice, data, text, video, video streaming, and/or video games for applications that may be disposed on mobile media players, multimedia portals, smart phones, such as iPhones and other like smartphones, tablet computers, including iPads and other like tablet computers, personal computers including PCs and Macs, web services, theater projection systems, set top boxes, DVD players, CD players, television, and may be utilized in conjunction with a plurality of container or wrapper formats over multiple communication networks and systems simultaneously. Further, the security application provides enhancements to the concatenated communication stream by applying multi-factor authentication, multiple encryption algorithms, multiple rotating keys for said encryption algorithms, and variable life spans for encryption key activation. The information that is being securely communicated may be files, data packets, voice packets, video packets, coding, passwords, usernames, and other like information, to and from dedicated media servers implemented in a cloud architecture via the Internet that inherently serves to be functionally ideal for the regional and/or global storage and distribution of media assets for commercial purposes. Each server may be dedicated in a one-to-one basis with the media player, becoming visible only when the player is activated. Each server, thus, may be knowledgeable of the authentication and encryption utilized by the player, thereby delivering communication packets in a proprietary format, shunting off the ability for any outside source attempting to modify or steal the transmission and basic understanding the packets.

The present invention employs specific ports and proprietary protocols, all controlled through a management system. There are generally no attack vectors against this approach.

The present invention specifically provides security processes and methodology to secure and make private all forms of media, mobile media, audio, audio streaming, video, video streaming and video games, and television from a library vault, to player download through the Internet, to computers, and onto mobile devices and/or other viewing and listening devices that are enabled for but not limited to receiving and playing movies, music, presentations, notifications, print-media, and other applications as apparent to one of ordinary skill in the art.

The systems and methods of the present invention may specifically be utilized to protect and secure the multimedia asset(s) and therefore protects and securitizes intellectual property, as defined by the Federal Copyright Act of the United States, by the multi-country member Anti-Counterfeiting Trade Agreement (ACTA), the Millennium Media Act, and any other legal acts, bills, guidelines, etc. that are germane to anti-piracy legislation.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a system for secured communications of media content from a content provider to an endpoint device in an embodiment of the present invention.

### DETAILED DESCRIPTION OF THE PRESENTLY PREFERRED EMBODIMENTS

### Definitions

“Agent” means a program executable on an endpoint or server to execute the preconfigured policy as defined on a server.

“Asymmetric Keys” (“public/private key pair”) means the public and private key pair used by a public key algorithm to authenticate a user's identity.

“Cloak” means to obscure information from the ability to be viewed or to render inconspicuous.

“Cloud” “is a computing terminology that pertains to a model for enabling convenient and scalable, on-demand network access to a shared pool of configurable computing resources (e.g., networks, servers, storage, applications, and services) via the Internet that may be employed to maximize efficiency and minimize operating costs for an enterprise.

“Communication Event” means a discrete act of communication by sending a set of data from a first user to a second user or a plurality of users, including, but not limited to, voice, text, file transfer, multimedia, and other like information transfer mechanisms on a network.

“Communication Session” means a period of time whereby a first user and a second user or a plurality of users are in direct contact with each other over a network whereby a communication event can occur between the first user and the second user or plurality of users.

“Container” means the cluster topology of an existing infrastructure applied to a cloud environment.

“Cyber Safe Room” means a virtual or physical location where access is achieved with one or more securely authenticated keys for entrance.

“Decloak” means to present information previously obscured from view or rendered inconspicuous as viewable or conspicuous.

“Dual-Phone” means any communications device that allows for more than one network interfaces for communications.

“End-point means any device that functions as the point to initiate a communicative action or interaction for the owner/user, like a PDA, smartphone, play station, computer, computer pad, monitoring device, and other like devices.

“Electronic Device” means any communication device that allows for the transmission of data from a first user to one or more destinations over a network, including but not limited to, telephones over standard PSTN networks, GSM cellular telephones, PDAs, Voice-over IP (VoIP) devices, dual-phones, desk top computers, traditional radio wave devices, standard display devices, such as televisions, including but not limited to LCD televisions, or other like display devices, or any other electronic device able to send data from a sender to a receiver.

“GSM” (“Global System for Mobile Communication”) means a telecommunications standard for mobile telephones.

“H-323” means protocols to provide audio-visual communication sessions on any packet network.

“Key Time Limit” means a time element, whether a starting time, ending time, or both a starting time and an ending time, during which the key can be used to decrypt encrypted data.

“Key Storage” means a repository of encryption keys for use within a security system.

“Library” means an electronic storage device containing media content.

“Memory Device” means components, devices and recording media that retain digital data used for computing.

“Multimedia” and “media” means all forms of media and content of different forms, and/or a combination of text, audio, still images, animation, video, and interactivity content forms (games, movies and television).

“Network” means a plurality of electronic devices connected together, whether wired or wireless, for the purpose of sharing data, resources and communication, including, but not limited to, PSTN telephone networks, GSM cellular telephone networks, radio wave networks and computer networks such as, but not limited to, the Internet, intranets, LAN, WAN, and other like computer networks.

“Passcode” means a form of secret authentication data that is used to control access to a source.

“NOC” or “Network Operating Center” refers to one or more locations to monitor and control computers, networks, televisions, and/or any transmission operation.

“Player” means any device that enables the user to initiate and view or listen to a media asset, like a movie or song.

“Player portal” means a site where the available media assets for potential renting and/or purchase are presented for commercial purposes.

“Player client distribution” refers to the process and methodology of media asset transition as a consequence of a renting and/or purchasing transaction.

“PDA” (“Personal Digital Assistant”) means handheld computers having a plurality of features including, but not limited to, some or all of: use as a calculating device, as a clock and calendar, for accessing the Internet, as a communication device such as, but not limited to, voice communications and/or for sending and receiving e-mails, for video recording, for typewriting and word processing, use as an address book, for making and writing spreadsheets, use as a radio or stereo, playing computer games, and/or use as a Global Positioning System (GPS) device.

“PSTN” (“Public Switching Telephone Network”) means the network of the world's circuit-switched telephone networks.

“Security Application” means a computer program stored in memory enabling secure transmission of data from a first user to a second user or a plurality of users.

“SIP” or “Session Initiation Protocol” means an application-layer control protocol for creating, modifying, and terminating sessions with one or more participants, including, but not limited to, telephone calls, multimedia distribution, and multimedia conferences.

“Symmetric Key” means a cryptographic algorithm that uses the same key for both encryption and decryption, or uses trivially related keys for encryption and decryption.

“TPM” (“Trusted Platform Module”) means the published specification detailing a microcontroller that can store secured information that offers facilities for secure generation of cryptographic keys, the ability to limit the use of keys as well as a Hardware Random Number Generator, among other functions.

“UICC” (“UMTS Integrated Circuit Card”) means the chip card used in mobile terminals in GSM and UMTS networks, also known as a “smart card.”

“UMTS” (“Universal Mobile Telecommunications System”) means one of the third generation (3G) mobile phone technologies, and is also known as “3GSM”.

“USIM” (“Universal Subscriber Identity Module”) means an application for UMTS mobile telephony running on a UICC smart card that is inserted in a 3G mobile phone.

“Video Streaming” means multimedia that is in constant communication streaming from a source via a telecommunications or data network for viewing by an end-user.

“VoIP” (“Voice over Internet Protocol”) means the routing of voice conversations over the Internet or through any other IP-based network.

The present invention relates to systems and methods for protecting and securing one-path and/or multi-path data, media, multi-media, simulations, gaming, television and mobile media communications and their fixed and/or mobile devices over diverse networks with symmetrical key rotation, various forms of encryption, and multiple factors of authentication to provide optimal security for the integrity of any media asset. The distribution of said media asset is driven through one or more virtual servers with effective stealth or cloaked process, rendering them invisible to outside attacks, and securing any media from internal theft during the distribution process. The present invention curtails the ability to copy and/or revise the protected media and is central to the prevention in the piracy of media assets.

An element of the systems and methods of the present invention involves a secure client application (SCA) that may be installed and run on one or more endpoint devices (including, but not limited to, smartphones, tablet computers, PC's, and other endpoint devices, as apparent to one of ordinary skill in the art) and one or more servers (terrestrial or cloud-based). The servers may be at any level, whether internal to a local network, or external to the Internet. The SCA may be downloaded to multimedia players, set top boxes, theater projector systems, and other like applications and devices, from said servers. Once installed, the SCA may have a unique identity, and will preferably only execute on the device it is installed on. If an attempt to copy the SCA is made by installing it on a similar endpoint, the SCA will not execute because it will not be authenticated for execution at that endpoint. In a similar fashion, the data, multi-media, audio, video, gaming communications, and other like media assets, will also not be playable on the endpoint it was “copied” to. Only an original SCA and an original media asset can be played or viewed on an endpoint when properly downloaded thereon.

The reception of data (meaning data, multi-media, audio, video, gaming communications, and other media assets) may come in two forms. The first is streaming. In the case of streaming, the data remains in the protected vault location of the media company (owners of the content media assets). The media assets may be received by the servers, as defined herein, and the media company may, thus, stream the data utilizing specific security methods to the SCA. The second method for the reception of data is in a download. In the case of downloading, the SCA partitions space on an endpoint device, which may then securely store the data for SCA execution at a later time.

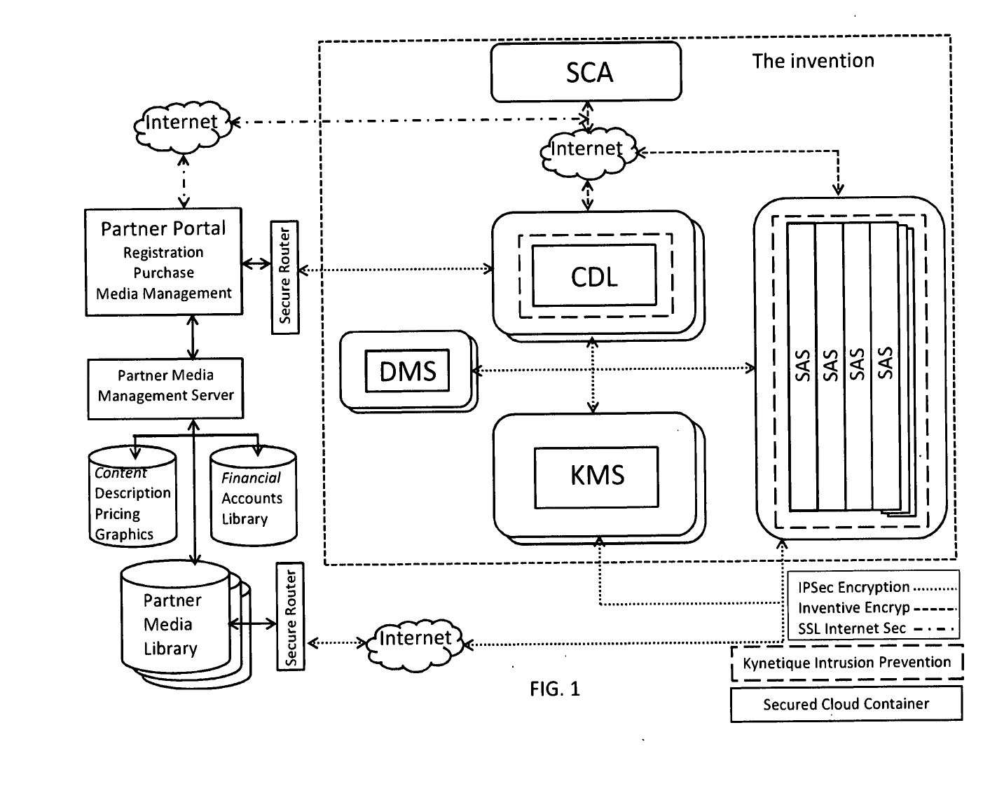

Secure application servers (SAS, as shown on FIG. 1) may be installed in a secure distribution center within a private cloud environment, enabling the user to initiate on-demand deployment of the SAS's, leveraging a cluster topology in one or more cloud environments. This provides capabilities for the securing of multimedia assets as it pertains to storage, rental or purchase payments, distribution, geospatial distribution, rapid SAS deployment, rapid SAS redundancy, and synchronization of data and functions between the one or more SAS's and SCA's. This synchronization of data includes but is not limited to SCA version management, and intercommunications between specific servers, as illustrated in FIG. 1.

The duality between the one or more servers and the one or more endpoints is part and parcel to the authentication and verification process of the systems and methods of the present invention. For each SCA, there is a dedicated SAS. The SAS is made aware of the SCA and is only active and, thus, only executes when the SCA is running. The relationship is a direct one-to-one relationship. And as a result, when the SCA is off, then the SAS, (which may typically be a cyber-attack surface), may be off, rendering the SAS effectively invisible. Additionally, the SCA may also be aware of the SAS in that when the SAS executes, it may do so with a different IP address each time it executes. This provides additional security through obfuscation.

In an embodiment, the communications between the SCAs and the SASs incorporate encryption technology including, but not limited to, AES 256 bit encryption and/or Blowfish 448 encryption. The invention can integrate or concatenate information communications and multi-media assets, including but not limited to voice, data, text, video, video streaming, and/or video games on applications including mobile media players, multimedia portals, web services, theater projection systems, set top boxes, and other like applications and devices, in a variety of container or wrapper formats, such as AIFF, WAV, XMF, FITS, TIFF, 3GP, ASF, AVI, DVR-MS, Flash Video, IFF, Matroska, MJ2, JPEG 2000, QuickTime File Format, MPEG program stream, MPEG -2 transport stream, MP4, Ogg, RM, NUT, MXF, GXF, ratDVD, SVI, VOB, DivX Media Format, JFIF, PNG, and other like container or wrapper formats, all of which may be securely communicated over multiple communication networks and systems simultaneously.

Multi-factor authentication of the SCA includes authenticating users based on at least two or more of the following: fingerprint recognition, facial recognition, iris recognition, voice pattern recognition, PIN code, IMEI code, geo-positioning vector input, media hashsums, OS hashsums, OS authentication keys, cipher application, pre-allocated alphanumeric code and/or server-to-device challenge response, including other like authentication protocols that may be apparent to one of ordinary skill in the art.

Further, the servers feeding the client applications provide a series of functions. In one embodiment, the Client Distribution and Licensing (CDL, as shown on FIG. 1) servers manage the distribution of client applications to smartphones, tablets, television, personal computers and other like endpoint devices. Where required by the platform vendor, the distribution of the application may take place on the hardware vendor's app store (e.g. Apples' app store on iOS or Mac), while the license management is completed on the CDL servers. When new client software is available, the software running the client software on smartphones, tablets, personal computers and other like endpoint devices, will receive notice of a new version available from either the endpoint vendor's app store, or through the CDL.

If required, the CDL has the ability of disabling an SCA on an endpoint device.

Finally, the CDL may be the main interface setup, maintenance, start-up and shutdown communications channel to the SCA. A dedicated SAS is preferably the only other application that would typically communicate to the SCA.

The Key Management Server (KMS, as shown on FIG. 1) repository is preferably the central repository of encryption and authentication and rotation of keys for individual installations of SCA's. Each SCA has a unique identity that is utilized for key generation. Elements of time, geospatial coordinates, and individual information are utilized in the creation of keys. The keys are generated on the device running the SCA. There is no central creation of keys within the invention. The KMS receives the keys through secured communications from the SCA through the CDL, and as such, does not appear on the Internet.

Keys may be rotated during the transmission of data. The key rotation duty cycle can be, but is not limited to, sub-second, second, sub-minute, hourly, sub-hour, daily, sub-daily, weekly, sub-weekly, and as required upon demand. Key rotation is described in copending U.S. patent application Ser. No. 11/890,421, entitled, “Systems and Methods for Conducting Secure Wired and Wireless Networked Telephony,” filed Aug. 6, 2007, and U.S. patent application Ser. No. 12/657,497, entitled, “Systems and Methods for Simultaneous Integrated Multi-encrypted Rotating Key Communications,” filed Jan. 21, 2010, each of which is incorporated herein in its entirety.

The SAS, KMS, and CDL all may run in one or more cloud environments (including but not limited to Amazon, IBM, Verizon/Terremark) within secure cloud containers. The cloud containers each provide their own protection against outsider and insider attack by shielding communications within and between other containers with IPSEC (Internet Protocol Security) communications. This approach generally provides the ability to communicate between cloud instances running in different global locations in a secure fashion. This approach further may provide the ability to rapidly create additional instances of a container for backup purposes. In addition, this approach may provide the ability to switch instances between other cloud locations within seconds. Moreover, this approach may provide the ability to run the same servers on different cloud providers for vendor diversity. Still further, this approach may provide the ability to shield data access of the servers deployed from the cloud vendor administrators and underlying server processes (often referred to as the hypervisor). Finally, this approach may provide the ability to securely connect to client data centers securely, allowing the SAS, DMS, KMS, and CDL server access to client information and the data, multimedia, audio, video, gaming, etc., in which, the invention is securely distributing.

All servers are preferably protected from attack, whether internal to a dedicated network, or external to the Internet. Specifically, the servers may be preferably protected via the systems and methods specified in U.S. patent application Ser. No. 12/673,450, entitled “High Performance, High Bandwidth Network Operating System,” filed Feb. 12, 2010 and U.S. patent application Ser. No. 12/809,984, entitled “Systems and Methods for Forensic Analysis of Network Behavior,” filed Jun. 21, 2010, each of which is incorporated herein in its entirety. The server protection specified herein will preferably only allow the specific network traffic into a secure container, which it expects, and no other. This is accomplished through port management (meaning, only “X” ports are open), and protocol management (meaning only specific protocols are allowed). The server protection specified herein also provides the ability to stop DDOS attacks of the SAS's.

The Distribution Management System (DMS, as shown on FIG. 1) manages all elements of the cloud containers. This includes understanding the current state of the container, all servers within containers, geographic location of all containers, and the interconnection between containers. The DMS will preferably define the terms of scalability of the servers within a container, the redundant containers, and automatically determine when a new container with the server protections specified herein and SAS's are needed for scale requirements. The DMS does not appear on the Internet, receiving all external communications through the CDL.

In one embodiment, the invention is utilized to protect streaming media content to SCA's deployed on (but not limited to) smartphones, tablets, PCs and other endpoint devices. The media content is effectively managed at the content provider's portal, however, the actual content never leaves the digital vault at the content provider's NOC. All content is securely streamed to the SCA via the secure containers and associated servers previously described.

The embodiment assumptions are:

1) The invention's servers are connected via IPSEC to a content provider's media vault.

2) The invention is deployed at two or more cloud providers, each interconnected via secured containers deployed with an enterprise account.

3) The geographic location of two or more cloud providers is disperse, and tuned to the probable location of the largest number of end users.

4) The media can be video, audio, or both.

5) The content provider is a studio, label, independent studio or label, and/or individual artist.

6) Intrusion prevention servers are utilized at every point where a standard Internet connection to a server is evident.

7) The encryption and authentication methods between the SCA and CDL, and the SCA and SAS, are specified in U.S. patent application Ser. No. 11/890,421, entitled “Systems and Methods for Conducting Secure Wired and Wireless Networked Telephony,” filed Aug. 6, 2007, and U.S. patent application Ser. No. 12/657,497, entitled “Systems and Methods for Simultaneous Integrated Multi-Encrypted Rotating Key Communications,” filed Jan. 21, 2010, each of which in incorporated herein in its entirety.

### Initiation and Process

An end user may have an endpoint device including (but not limited to) smartphones, tablets, PCs and other endpoint devices, which have Internet access, and an account at the content provider's (studio, label, etc.) portal. Through a standard web browser from any of his/her endpoints, the end user selects a method of content purchase from the content provider. If the end user has not done so previously, the end user downloads the SCA to their endpoint device (smartphone, tablet, etc.) of choice. Upon installation, the SCA establishes a unique license key with a hash determined by, but not limited by, elements of the hardware (including but not limited to NIC, GUID, and/or other like elements of the hardware), information of the end user (including but not limited to address, phone numbers, and/or other like information of the end user), time of purchase (MMDDYYY), phase of the moon, GPS location (if available), cell number associated with the endpoint device (if available), and/or other like elements apparent to one of ordinary skill in the art to determine the hash of the unique license key. Once calculated, the unique license key is saved on the end point device as a doubly encrypted file with restricted access to only the SCA.

This is followed by the generation of a series of encryption keys, saved on the SCA endpoint in a doubly encrypted format. Each key may be a master key of keys, where many (1->1,000,000) individual subkeys may be created (as described in U.S. patent application Ser. No. 11/890,421, entitled “Systems and Methods for Conducting Secure Wired and Wireless Networked Telephony,” filed Aug. 6, 2007 and incorporated herein in its entirety) which are reserved for future use. Additionally, a series of master keys (1-n) may be created for current and future uses.

The SCA then preferably communicates to the CDL in a doubly encrypted fashion (for example, using AES and Blowfish with varying bit widths as apparent to one of ordinary skill in the art), registering itself with the CDL. Once registered, the master keys are preferably sent to the CDL for persistent storage in the KMS.

### Nominal Usage (Post Installation)

In order to view or listen to any data from the content provider (label, studio, etc.), the end user may preferably have an account with the content provider. This is accomplished through standard Internet mechanisms whereby the content provider maintains a portal with an inherent understanding of the general offerings. These could include but are not limited to monthly subscriptions or one time viewing/listening to the content provider's “for sale” content. Any purchases or financial transactions made are managed by the content provider's portal infrastructure.

When the SCA is launched, a series of communications take place in order for the SCA to access the purchased media. Upon launch, the SCA validates its license with the CDL. This and all communications between the CDL and SCA are uniquely encrypted with one of the keys defined above. Both the SCA and CDL will understand which subkey to use, based on a series of factors, including but not limited to the elements described in the KMS section above. This interaction preferably occurs with every launch of the SCA. If the SCA on an endpoint device is not properly registered with the CDL, then the CDL communicates such to the SCA, and the SCA terminates after indicating a registration error has occurred. If the CDL determines a proper registration, then the CDL sends a message to the SCA indicating such.

Next, the SCA preferably sends a message asking whether there is an update of the SCA software. Thus, the SCA, sending a message requesting an update of SCA software represents an asset and a change of state of the asset, and concurrent communication based on the change in state, as described in more detail in U.S. patent application Ser. No. 11/508,773, entitled, “System and Method for Communications and Interface with Assets and Datasets,” filed on Aug. 23, 2006, the entirety of which is expressly incorporated herein. If there is, then the CDL can perform the update with the SCA, or, in the case of Apple iOS, the SCA software does nothing. Apple updates software via its own mechanism—the Appstore.

Next, after the CDL determines proper registration, the CDL then preferably notifies the DMS that a SCA instance has been started for a specific endpoint device and end user client. The DMS performs a series of steps:

1) It determines the location of the SCA through geospatial analysis from the SCA's IP address, and determines the closest secured cloud container available for a dedicated SAS instance.

2) It determines which secure container instances are available for a new SAS instance, based on current cloud and network performance.

3) It determines the IP address that will be used for a SAS server instance.

4) It launches a SAS server instance in a specific cloud and secure container instance.

5) It reserves an existing, running SAS instance from a pool of running servers running in the same cloud and secure container instance from the previous step, and dedicates it to the SCA.

6) It queries the DMS for the master keys the respective SCA is running with, and sends them to the SAS dedicated SCA.

7) It queries the partner's portal for the list of data/media/audio the end client has access to, and sends descriptor links or indexes of the respective data/media/audio to the dedicated SAS.

Next, the dedicated SAS instance queries the content provider's media vault to receive specific pointers to the media available to the end client for rapid media access. Once received, it updates the DMS of status. Once this status is received, the DMS, through the CDL, preferably sends a message to the SCA of the status and IP address of the dedicated SAS.

Next, the SCA queries the SAS for available media. The SCA has the ability to choose media, and request the viewing or listening of the media. The SCA preferably has the ability to play both audio and video via known codecs. Upon receiving the request from the SCA, the SAS begins streaming the chosen audio or video to the SCA, encrypted with the master keys, in either a nominal single key encryption, or rotation of keys (as described in U.S. patent application Ser. No. 12/657,497, entitled “Simultaneous Integrated Multi-Encrypted Rotating Key Communications,” filed Jan. 21, 2010 and incorporated herein in its entirety). The keys specifically are preferably not sent between the SCA and SAS, since they both have the master and sub keys, and they both know which master sub key to utilize and sequence, as well as the timing for the rotation.

The SCA preferably buffers at least 30 seconds of content on the endpoint device before playing of the media begins. This is done to provide a pleasant user experience in less than average network areas.

The SCA will preferably indicate poor network performance before the media is started, and will ask the user whether they wish to continue.

The SCA also preferably has the ability to pause the streaming media for a period of 5 minutes. After 5 minutes, the streaming media may be stopped.

The SCA will also preferably have the ability to request from the SAS a start of a stream of media from any location in the media.

Throughout operations, the SAS sends out heartbeats to the DMS on a sub-minute and/or queried basis.

Of specific note, when this process is repeated on the same endpoint running a SCA, asking for the same content, the encryption stream will preferably be different on each request. The keys utilized will preferably have a temporal element associated with them, and will preferably utilize a different subkey on each end user request, whether the sub key is static, or whether it is rotated.

In another embodiment, the invention has the ability to not only address streaming media, it has the ability to address the download of media to a user's endpoint device, utilizing the same security methods as described above.

With respect to streaming media using the systems and methods of the present invention, the methods and processes are nearly identical to the embodiment described above. The SCA software has an additional element, secured persistence storage. This storage could persist for infinity, or it could persist for a matter of hours or days, depending on the marketing program a content provider desires. Specifically, as described in U.S. patent application Ser. No. 11/890,421, incorporated herein in its entirety, the SCA would have preferably received encryption keys from the CDL specific for the downloaded content. The encryption keys would preferably contain a start date/time and an end date/time. If the purchase of the downloaded media were a complete user license, then the end date and time would be open. However, if the purchase were limited to a number of hours or days, then the key would have a specific end date/time. The SCA is preferably capable of playing the downloaded content if the keys are valid. When the SCA checks the actual date/time via an Internet clock against the encryption keys in the system, and then determines the relationship of an encryption key to the media, the SCA: a) offers extended time for the downloaded media, executing a transaction with the content provider's portal; or b) deletes the downloaded media and encryption key. If the latter occurs, no further action is required from the content provider. The downloaded media simply no longer exists.

In addition, the SCA may be offered to the content provider in a branded fashion, allowing the content provider to expand their targeted marketing efforts. An example of this is the concatenation of old content into a new platform and a branded offering with a secure media player.

The SCA has the ability to store purchased content as opposed to maintaining the media content on the account with the content provider. In this case, client would purchase the content at a defined price from the content provider's portal. At a point in time subsequent to purchase, the SCA would access the purchased content information from the DMS through the CDL, and prepare for a download of content from a newly started SAS.

The process flow is preferably as follows:

1) Having previously established an account, the end user makes a purchase of downloadable media from the content provider's portal.

2) The end users starts the SCA.

3) After the CDL determines proper registration of the SCA, it then notifies the DMS that a SCA instance has been started for a specific endpoint device and end user client. The DMS performs a series of steps:
a) The CDL determines the location of the SCA through geospatial analysis from the SCA's IP address, and determines the closest secured cloud container available for a dedicated SAS instance.
b) It determines which secure container instances are available for a new SAS instance, based on current cloud and network performance.
c) It determines the IP address that will be used for a SAS server instance.
d) It launches a SAS server instance in a specific cloud and secure container instance.
d) It reserves an existing, running SAS instance from a pool of running servers running in the same cloud and secure container instance from the previous step, and dedicates it to the SCA.

4) The DMS asks the KMS to create a set of unique encryption keys with a temporal element of start date/time and send date/time. The DMS receives the keys, and sends them doubly encrypted to the SCA through the CDL. The DMS also sends the keys to the dedicated SAS. The DMS additionally send a message to the SCA that the media is ready for download. The DMS finally maintains the status of the download.

5) The end user requests the download of the media in the SCA. The SCA communicates with the dedicated SAS, downloading the media.

6) Once the media has been successfully downloaded, the DMS terminates the dedicated SAS and deletes the dedicated keys in the KMS.

In an example of the present invention, the systems and methods of the present invention, as described above, have the ability to secure media access and distribution during the media development and production process. In general, and prior to the systems and methods of the present invention, there has previously been virtually no encryption and multi-factor authentication security during the development and production of any new media, be it audio or video. Utilizing the systems and methods of the present invention, samples, takes, drafts, final cuts, and other like generated production media, would all be available in a remote fashion when connecting the present invention's SAS to the development and final production media vault.

In this example, the systems and methods of the present invention allows for access to any endpoint device including, but not limited to, smartphone, tablet, PCs and/or other endpoint devices, for viewing the library of media development, to any global location over the Internet with complete security.

Examples could include:

Media review of any stage of development by stakeholders, executives, artists, producers, directors, prospective clients, and/or others desiring media review at any stage of development.

In another example of the present invention, the systems and methods of the present invention have the ability to secure media access and distribution of corporate multimedia communications to other executives, members of the board, strategic partners, large shareholders, all shareholders, and/or other like interested parties The present invention, thus, may be utilized, as the means for communications distribution of a firm's financials, material events and/or other important information.

Previously, there has been virtually no encryption and multi-factor authentication security in the distribution of audio and video at the senior ranks in firms and businesses. Utilizing the systems and methods of the present invention, as described herein, communications from stakeholders to general staff could be completed via the invention, ensuring the secure delivery of communications from the executive staff, marketing, public relations, operations, security operations, and/or other functions of a firm or business.

In this example, the invention functions as described above and allows for access to any endpoint device, including but not limited to smartphone, tablet, PCs and/or other endpoint devices for viewing the library of media development, to any global location over the Internet with complete security.

In another example, the systems and methods of the present invention have the ability to secure media access and distribution of media of patient multimedia records in the healthcare industry. Secured access to client multimedia records may be achievable for primary physicians, specialists, consulting physicians, clinics, hospitals, clients, insurance companies, and/or other like healthcare partners via the systems and methods described herein.

Previous to the systems and methods described in the present invention, there has been limited encryption and multi-factor authentication security in the distribution of multimedia in healthcare. Secured access to X-rays, MRI's surgical procedures, and/or other like healthcare information, would be globally available to a series of stakeholders for any patient. In this example, the systems and methods described above allows for access to any endpoint device including but not limited to smartphone, tablet, PCs and/or other endpoint devices for viewing the library of media development, to any global location over the Internet with complete security.

In another example, the invention has the ability to secure distribution of production content to digital theaters, televisions, set-top boxes, and other like content players. The delivery system is very similar to systems and methods described above. However, the SCA needs to be integrated into the digital theater systems, televisions, Set-Top boxes, and other like content players.

In addition, the present example would provide the ability for media companies of all types and sizes to market to end users on traditional home environments directly, and provide for a secure distribution method of content to digital theaters, eliminating external and internal theft of media at the digital theaters.

In another example, the systems and methods of the present invention have the ability to secure media access and distribution of video gaming content. In a similar fashion as described above, the invention could be built into end user gaming platforms for the distribution of games electronically within the endpoint system. The games could be purchased in perpetuity and stored on the endpoint devices. Alternately, the games could be purchased as time based licenses, expiring at a point in time, such as when the encryption key end date/time expires, as described above.

The present example may be useful to prevent attacks and theft of data relating to game modules, such as the recent attacks and theft from Sony relating to the Sony PlayStation media console.

In another example, the systems and methods of the present invention have the ability to secure media access and distribution of closed circuit television and/or the equivalent thereof. Whether the media content associated with the closed circuit television or equivalent thereof relates to sports entertainment, private tradeshows, security management or monitoring, satellite or drone imagery and/or other like media, the present invention described herein can provide secured media distribution to a series of industries and government agencies where real-time or stored multimedia could be viewed and listened to over the Internet.

In a similar fashion as described above, the invention could be accessible anywhere by registered users. The multimedia could be purchased and accessed in perpetuity and stored on the endpoint devices. Alternatively, the multimedia could be purchased as time based licenses, expiring at a point in time, such as expiring when the encryption key end date/time expires, as described above.

In another example of the present invention, the systems and methods described herein have the ability to secure media access and distribution of gaming content within the facilities, cities, counties and states where gabling (at times referred to as gaming) is legalized. In a similar fashion as described above, the invention could be built into end user gaming platforms for the distribution of games electronically within the endpoint system. It could also be made available throughout the legal area on commercial devices within the jurisdictions, managed and monitored via GPS location for gaming jurisdiction enforcement. The devices could be rented or provided free by casinos, leveraging the existing gaming manufacturing software already prevalent throughout casinos.

In another example, the systems and methods of the present invention have the ability to secure most any type of data access with the integration of the data vault to the invention's infrastructure, and the customization of the SCA, or integration of SCA processes into existing client applications. In an example, the systems and methods described herein could be utilized to secure social networking, allowing for private communications of text, multimedia, audio, video, and/or other like communications, within a social media structure.

Thus, attacks on social media structures, such as the cyber-attacks on Google, Amazon, Yahoo, Facebook, Twitter, etc., may be prevented.

It should be noted that various changes and modifications to the presently preferred embodiments described herein will be apparent to those skilled in the art. Such changes and modifications may be made without departing from the spirit and scope of the present invention and without diminishing its attendant advantages.

We claim:

1. A method of delivering secure multimedia content comprising the steps of:
providing an endpoint device;
providing a mobile media application player on the endpoint device; and
delivering secured multimedia content to the endpoint multimedia device via one or more dedicated physical or virtual servers, including cloud computing infrastructures to play on the mobile or fixed media application player, wherein the secured multimedia content is uniquely encrypted to play only on the mobile media application player on the endpoint device.
